(19) United States
(12) Patent Application Publication
(10) Pub. No.: US 2004/0193322 A1
(43) Pub. Date: Sep. 30, 2004

(54) Vision-and environment-based programming of robots and/or computer systems

(76) Inventors: Paolo Pirjanian, Glendale, CA (US); Barton Elliott Listick, Agoura Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/754,917

(22) Filed: Jan. 9, 2004

Related U.S. Application Data
(60) Provisional application No. 60/439,047, filed on Jan. 9, 2003.

(51) Int. Cl. G06F 19/00

(52) U.S. Cl. 700/259; 700/245; 318/568.12

(57) ABSTRACT

The invention is related to methods and apparatus for programming and/or control of a computer system via a video camera or other imaging device. Objects in the environment, such as printed cards, can be placed within the field of view of the video camera or other imaging device. Indicia on the cards can be recognized and associated with one or more programming instructions or computer commands for control. In one embodiment, a computer system that is programmed and/or is controlled corresponds to a robot, such as a stationary robot or a mobile robot.

### RELATED APPLICATION

This application claims the benefit under 35 U.S.C. §119(e) of U.S. Provisional Application No. 60/439,047, filed Jan. 9, 2003, the entirety of which is hereby incorporated by reference.

### BACKGROUND OF THE INVENTION

1. Field of the Invention

The invention generally relates to programming and/or control of computer systems. In particular, the invention relates to programming and/or control of a computer system, such as a stationary or a mobile robot, via recognition of visual indicia, such as graphics, text, pictures, and the like, using a visual sensor such as a camera.

2. DESCRIPTION OF THE RELATED ART

Computer systems operate by running computer programs. These computer programs include a collection of instructions. Computer programs can be written in a variety of languages, which can be compiled or interpreted.

In many conventional programming environments, a software developer manually types in source code using a keyboard and a monitor to write software. In addition to writing software code in a logically-correct manner, a software developer must also write syntactically-correct software code. The learning of software syntax can be relatively complicated, and thus software development is typically a skill not possessed by an ordinary user of a computer system.

In the context of a robot, a software developer may write software for tasks such as motion, navigation, robot behavior, and the like. However, not all of the anticipated users of a robot can be expected to possess the training of a skilled software developer.

### SUMMARY OF THE INVENTION

Embodiments of the invention include methods and apparatus for programming and/or control of a computer system via a video camera or other imaging device that is coupled to the computer system. The computer system that is programmed and/or is controlled can correspond to, for example, a robot. Objects in the environment, such as printed cards, can be placed within the field of view of the video camera or other imaging device. Indicia on the cards can be recognized and associated with one or more programming instructions or computer commands for control.

One embodiment is a method of programming a device, where the method includes: providing a plurality of card-like objects, where at least one surface of the card-like objects includes indicia, wherein at least a portion of the indicia is machine readable and at least a portion is human recognizable; visually recognizing the indicia on at least some of the card-like objects using an image recognition process; associating the recognized indicia with one or more executable program instructions; and arranging the one or more executable program instructions to create at least a portion of a computer program.

Another embodiment is a method of programming a device, where the method includes: visually recognizing indicia that are visible on at least one surface of one or more planar objects, where at least one surface of the planar objects includes indicia, where at least a portion of the indicia is machine readable and at least a portion is human recognizable; automatically associating at least some of the recognized indicia with one or more executable program instructions; and arranging the one or more executable program instructions to create at least a portion of a computer program for the device.

Another embodiment is a method of controlling a machine, where the method includes: visually observing indicia that are visible on at least a surface of an object, where the indicia are at least partially machine readable and at least partially human recognizable, where at least some of the indicia is associated with a desired behavior for the machine; associating the recognized indicia with corresponding behavior based at least in part on data retrieved from a data store; and controlling a behavior of the machine according to the recognized indicia.

Another embodiment is a set of computer control cards, where the set includes: a plurality of cards with visually-recognizable indicia, where the indicia are intended to be at least partially machine readable and are intended to be at least partially human recognizable, where the indicia are associated with at least one of computer commands and computer programming statements, where the associations between the visually-recognizable indicia and the at least one of computer commands and computer programming statements are stored in a computer data store; where the cards further include: a plurality of cards with indicia associated with operators; a plurality of cards with indicia associated with flow control; a plurality of cards with indicia associated with actions for a computer; and a plurality of cards with indicia associated with command parameters.

One embodiment is a computer program embodied in a tangible medium for controlling a device, where the computer program includes: a module with instructions configured to visually recognize indicia that are visible on at least one surface of one or more planar objects, where at least one surface of the planar objects includes indicia, where at least a portion of the indicia is machine readable and at least a portion is human recognizable; a module with instructions configured to automatically associate at least some of the recognized indicia with one or more executable program instructions; and a module with instructions configured to arrange the one or more executable program instructions to create at least a portion of a computer program.

One embodiment is a circuit for controlling a device, where the circuit includes: a circuit configured to visually recognize indicia that are visible on at least one surface of one or more planar objects, where at least one surface of the planar objects includes indicia, where at least a portion of the indicia is machine readable and at least a portion is human recognizable; a circuit configured to automatically associate at least some of the recognized indicia with one or more executable program instructions; and a circuit configured to arrange the one or more executable program instructions to create at least a portion of a computer program.

One embodiment is a circuit for controlling a device, where the circuit includes: means for visually recognizing indicia that are visible on at least one surface of one or more planar objects, where at least one surface of the planar objects includes indicia, where at least a portion of the indicia is machine readable and at least a portion is human recognizable; means for automatically associating at least some of the recognized indicia with one or more executable program instructions; and means for arranging the one or more executable program instructions to create at least a portion of a computer program.

### BRIEF DESCRIPTION OF THE DRAWINGS

These and other features of the invention will now be described with reference to the drawings summarized below. These drawings and the associated description are provided to illustrate preferred embodiments of the invention and are not intended to limit the scope of the invention.

FIG. 1 illustrates a flowchart that generally illustrates a process for programming a computer system.

FIG. 2 illustrates examples of card designs.

### DETAILED DESCRIPTION OF PREFERRED EMBODIMENTS

Although this invention will be described in terms of certain preferred embodiments, other embodiments that are apparent to those of ordinary skill in the art, including embodiments that do not provide all of the benefits and features set forth herein, are also within the scope of this invention.

Embodiments of the invention include methods and apparatus for programming and/or control of a computer system via a video camera or other imaging device that is coupled to the computer system or “computer.” The computer system that is programmed and/or is controlled can correspond to, for example, a device with a programmable processor, such as a microprocessor or a microcontroller, and not just to a desktop PC or to a laptop computer. Advantageously, objects in the environment, such as printed cards, can be placed within the field of view of the video camera or other imaging device. Indicia on the cards, as well as other visual features and/or cues in the environment, can be recognized and associated with one or more programming instructions or computer commands for control. Advantageously, this permits mobile computing platforms, such as robots, to perceive, parse, and execute actual programming statements that are placed in the robot's environment. Further advantageously, this permits programs to be “written” efficiently and with relatively little time spent learning the intricacies of software syntax. In addition, the programming and/or control of a computer system via visual indicia present on cards advantageously permits a computer system to be programmed even in the absence of conventional data input or data output devices used during programming, such as keyboards, displays, and mouse devices.

Examples of embodiments will now be described. Although embodiments of the invention will be described in the context of a robot, it will be understood by the skilled practitioner that the principles and advantages described herein will also be applicable to a wide variety of computer systems. These computer systems described may be single-processor or multiprocessor machines. Additionally, these computer systems include an addressable storage medium or computer accessible medium, such as random access memory (RAM), an electronically erasable programmable read-only memory (EEPROM), flash memory, hard disks, floppy disks, laser disk players, digital video devices, Compact Disc ROMs, DVD-ROMs, video tapes, audio tapes, magnetic recording tracks, electronic networks, and other techniques to transmit or store electronic content such as, by way of example, programs and data. In one embodiment, the computer systems are equipped with a network communication device such as a network interface card, a modem, Infra-Red (IR) port, or other network connection device suitable for connecting to a network. Furthermore, the computer systems execute an appropriate operating system such as Linux, Unix, Microsoft® Windows® 3.1, Microsoft® Windows® 95, Microsoft® Windows® 98, Microsoft® Windows® NT, Microsoft® Windows® 2000, Microsoft® Windows® Me, Microsoft® Windows® XP, Apple® MacOS®, IBM® OS/2®, Microsoft® Windows® CE, or Palm OS®. As is conventional, the appropriate operating system may advantageously include a communications protocol implementation, which handles incoming and outgoing message traffic passed over the network. In other embodiments, while the operating system may differ depending on the type of computer system, the operating system may continue to provide the appropriate communications protocols necessary to establish communication links with the network.

The computer systems may advantageously contain program logic, or other substrate configuration representing data and instructions, which cause the computer system to operate in a specific and predefined manner as described herein. In one embodiment, the program logic may advantageously be implemented as one or more modules. The modules may advantageously be configured to reside on the addressable storage medium and configured to execute on one or more processors. The modules include, but are not limited to, software or hardware components, which perform certain tasks. Thus, a module may include, by way of example, components, such as, software components, object-oriented software components, class components and task components, processes, methods, functions, attributes, procedures, subroutines, segments of program code, drivers, firmware, microcode, circuitry, data, databases, data structures, tables, arrays, and variables.

It will also be understood by the skilled practitioner that while embodiments are generally described in the context of indicia printed on planar objects, such as cards and/or card-like objects, which can be fabricated from paper, such as card stock, the indicia can also be present on other objects that are observable by a visual sensor. The visual sensor can correspond to a digital camera with a CCD imager, a CMOS imager, an infrared imager, and the like. The visual sensor can include normal lenses or special lenses, such as wide-angle lenses, fish-eye lenses, omni-directional lenses, and the like. Further, the lens can include reflective surfaces, such as planar, parabolic, or conical mirrors, which can be used to provide a relatively large field of view or multiple viewpoints. Another example of a visual sensor is an optical scanner, such as a bar-code scanner, that uses a laser to scan.

A computer system can be programmed to perform a broad variety of tasks. Examples of computer programs can include utilitarian programs, control programs, entertainment programs, and the like. Examples of these programs include word processing software, data processing software, speech recognition software, software for controlling lights, for controlling temperature, control of a robot, including a toy robot, for gaming, and the like. Software can also be used in a robot. For example, software can be used to control at least some of the behavior of a robot, such as movement of a robot. Embodiments of the invention can advantageously be used to program a robot, control the robot, or both program and control the robot. It will be understood by the skilled practitioner that a computer system used in a robot can also include dedicated hardware for processing of at least a portion of its functions.

Modes

A variety of modes can be used. For example, one embodiment of the system can alternate between at least two modes, such as a “learn” mode and an “execute” mode. In the “learn” mode, the system identifies token cards, which can be presented sequentially or in a group as a collection, parses the token cards, and builds a program; When operating in an “append” sub-mode, instructions corresponding to a new card or set of cards are appended to instructions corresponding to the previously accepted card or set of cards. When not operating in append sub-mode, each set of cards should form a syntactically complete program (or macro sub-routine).

In an “execute” mode, which can be entered, for example, upon recognition and association of a “start” card with a start command, a program is executed. If a program exists, e.g., if a saved program has been loaded or if a new program has been entered in learn mode, then the computer system or robot can begin executing the program. If no program has been loaded or entered into memory, one embodiment of the system enters execute mode and executes program instructions that are associated with cards encountered in a visual field. In one embodiment, a set of identified cards can be parsed and, if they correspond to a syntactically correct program, executed promptly, such as by overriding a currently-executing program or macro sub-routine. For mobile computing platforms, such as robots, an ability to perceive, parse, and execute programming statements that are placed in the robot's environment advantageously represents a new paradigm in programming and control.

Process for Programming

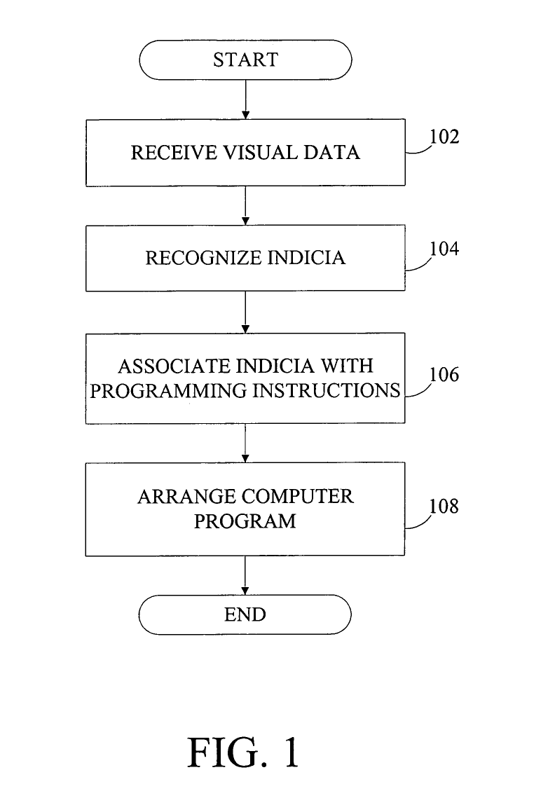

FIG. 1 illustrates a flowchart that generally illustrates a process for programming a computer system, such as a computer system for a robot. It will be appreciated by the skilled practitioner that the illustrated process can be modified in a variety of ways without departing from the spirit and scope of the invention. For example, in another embodiment, various portions of the illustrated process can be combined, can be rearranged in an alternate sequence, can be removed, and the like. The process begins at a state 102. In the state 102, the process receives or monitors visual data, such as data from a video camera. In one embodiment, the indicia are advantageously visually detected without physically touching the objects displaying the indicia. The visual sensor can also correspond to an optical scanner, such as a bar-code scanner. Advantageously, such visual sensors are relatively inexpensive and are commonly used with robots, such that the use of data from a visual sensor for programming and/or control adds little or no additional cost to a robot. The process advances from the state 102 to a state 104.

the process analyzes the visual data for recognition of indicia. A variety of visual recognition techniques can be used, and it will be understood that an appropriate visual recognition technique to use can depend on a variety of factors, such as the visual sensor utilized and/or the visual indicia used. In one example, the indicia are identified using an object recognition process that can identify visual features. In one example, the visual features identified correspond to SIFT features. The concept of SIFT has been extensively described in the literature. See David G. Lowe, Object recognition from local scale-invariant features, Proceedings of the International Conference on Computer Vision, Corfu, Greece (September 1999) and David G. Lowe, Local Feature View Clustering for 3D Object Recognition, Proceedings of the IEEE Conference on Computer Vision and Pattern Recognition, Kauai, Hawaii (December 2001). In another example, the indicia are identified by reading a printed code, such as a bar code or a colored bar code. It will be understood that such a process can also be embodied in a dedicated hardware circuit. Other appropriate techniques will be readily determined by one of ordinary skill in the art. The process advances from the state 104 to a state 106.

the process associates the recognized indicia with programming instructions, macros, subroutines, arguments, and the like. For example, the association of indicia with a set of programming instructions can be maintained in and retrieved from a data store, such as a database. The associations can be provided on a relatively inexpensive disk, such as a CD-ROM, can be downloaded from a network, and the like. The process advances from the state 106 to a state 108.

the process arranges the computer program from the instructions. The process can arrange the computer program based on, for example, a sequence of cards recognized by the process. Where more than one card is shown at a time, the process can organize the computer program based on the relative positions of the cards. For example, the process can organize the computer program based on a left-to-right and a top-to-bottom ordering of the cards. The program can then be interpreted or compiled and executed or combined with other routines and/or subroutines and then executed. It will be understood that the process illustrated in FIG. 1 can also be used to associate a variety of indicia with a variety of commands to control a computer system, such as a robot.

One embodiment of the system maintains an internal state machine, which advantageously determines what actions the system will perform during a cycle. The state machine can maintain a “ready” state when the state machine is waiting for new visual input.

The system finds command cards, token cards, or other identifiable objects in the image frame received from the camera. In one implementation, the system uses object recognition to identify the cards and objects. In another implementation, the system uses a code, such as a bar code or a colored bar code, printed on the cards for identification.

When a known object is detected, the system initiates a process of sorting and cleaning, where the system determines which matches are valid and which are spurious (in some instances, multiple hits for the same card may be received with slightly different coordinates), using geometrical intersection to determine spurious matches (e.g., cards overlapping by an undesirable amount), and the physical 2-D locations to determine the left-to-right, top-to-bottom order of the cards (when a set of cards is presented). It will be understood that the system can be configured to arrange the order in a different sequence.

In one embodiment, when one or more valid matches are found, the system can optionally wait for one or more extra cycles to compare the matched card or cards from these extra cycles, so that the system can more reliably determine the true card set. In one implementation, the system requires that the matched set be identical for two or more cycles. Another implementation computes the statistical probability that each card is present over several cycles.

Instructions associated with cards can be appended to a program or can be used standalone. When a stable set of cards is determined, the associated instructions can be appended to a program (when the system is in “append” mode), treated as a standalone program or sub-routine (when the system is not in append mode), or the like. The system can then return to the “ready” state.

If objects disappear before a stable match is found, the system can proceed to an “empty” state. If new objects are observed while the system is in the empty state, the system can return to the ready state and can proceed to validate the objects (as described above). If the system remains in the empty state for a preset number of cycles, the system can automatically return to the ready state.

When in the ready state, the system's parsing and execution can be triggered in a number of ways. For example, in a “quick execute” mode, the system can repeatedly check whether the current program is valid; if so, the system will execute the program promptly, by switching to an “execute” state. In a normal mode, a “start” card can be used to trigger the parsing of the program, by switching to a “parse” state. If the program is correctly parsed, the machine switches to the execute state.

In an execute mode, the sequence of parsed statements can be executed one by one. If the statement corresponds to a “macro run,” the current program counter is pushed to a stack, and then reset to the start of the macro. When a macro execution is complete, the program counter is popped from the stack, so that execution of the calling program resumes from the next statement.

The execution of selected statements can require switching to special states. For example, selected robotic motion commands may persist in a “motion” state until the robot notifies the system that it has completed moving or rotating.

Table I illustrates examples of operators for instructions. For example, these operators can be associated with indicia for program instructions.

TABLE I
Operators

| | |
|---|---|
| +, −, /, ×, | Arthmetic: add, subtract, divide, multiply |
| =, <>, <, <=, >, >= | Comparison: equal, not equal, less than, less than |
| | or equal, greater than, greater than or equal |

Table II illustrates examples of flow control instructions.

TABLE II
Flow Control

| | |
|---|---|
| [condition][action] | If (condition), perform action |
| [condition][action1] | If (condition), perform action1 else perform action2 |
| [:][action2] | |
| [repeat][number] | Loops a number of times performing the action |
| [action] | each time (a repeat count of 0 (default) means |
| | repeat forever) |
| [break] | Break out of current loop |
| (,),: | Symbols used to disambiguate |

Table III illustrates examples of conditions and actions that can be used in, for example, commands.

TABLE III
Conditions and Actions

| | |
|---|---|
| Start | Card held up (and button on robot) to start the program |
| | (starts macro 0) |
| End | Card held up (and button on robot) while program is still |
| | running to end program |
| Suspend | Card held up (and button on robot) while program is |
| | running to suspend execution (Restarted with “Start”) |
| Exit | Card held up (and button on robot) to end application |
| Lock Mode | Lock mode; robot will not respond to new commands it |
| | sees |
| Verbose Mode | Set verbose mode; robot says each command as it is |
| | executed |
| Input | Input types: 0 = yes/no, 1 = number, 2 = text, 3 = object |
| Macro define | The subsequent commands will define this macro |
| Macro list | Verbally list macro definition |
| Macro run | Runs the macro and waits for it to finish |
| Macro stop | Stops the macro program (useful for stopping concurrent |
| | macro) |
| Macro start | Starts the macro and returns immediately (for concurrent |
| | macros) |
| Macro done? | Useful for checking up on concurrent macro |

Table IV illustrates examples of commands and/or instructions that can be used for the control of a robot.

TABLE IV
Robot Control

| | |
|---|---|
| Object | Manipulation codes: 0 = touch object, 1 = grab object, |
| manipulate | 2 = release object. |
| Arm move | Direction codes: 0 = up, 1 = down |
| Robot move | Default: feet |
| Find | Begins executing search routine to explore space and find |
| | object. One default can be to look for all known objects. |
| | Can also add “Find Person” and “Find Color” commands. |
| Follow | Follow object, keeping within given distance. |
| Speed | Sets speed for move commands (default: inches per |
| | second) |
| Robot rotate | Default: 90 degrees |
| Go to | Go to known SLAM location (room) or user-defined |
| location | “home” |
| Record | Default: 1. Three seconds of silence ends recording. |
| sound | |
| Play sound | Default: 1 |
| Speak | Using text-to-speech; can include dictionary word lookup |
| Music play | Plays a pre-recorded song |
| Assign var | Assigns number, text, variable or result of operation to a |
| | variable |
| Object load | Associate a previously trained object with object n |
| Color learn | Train the robot on a particular color |

Table V illustrates arguments and parameters that can be used in programming instructions or with commands.

TABLE V
Arguments and Parameters

| | |
|---|---|
| Digits (0-9) | |
| Letters (A-Z) | |
| Space Symbol | |
| [Variable] | Is followed by variable number. Can be used in place of |
| | a literal argument above. |
| [Local | Used in special “system” macro callbacks |
| Variable] | |

Sample Cards

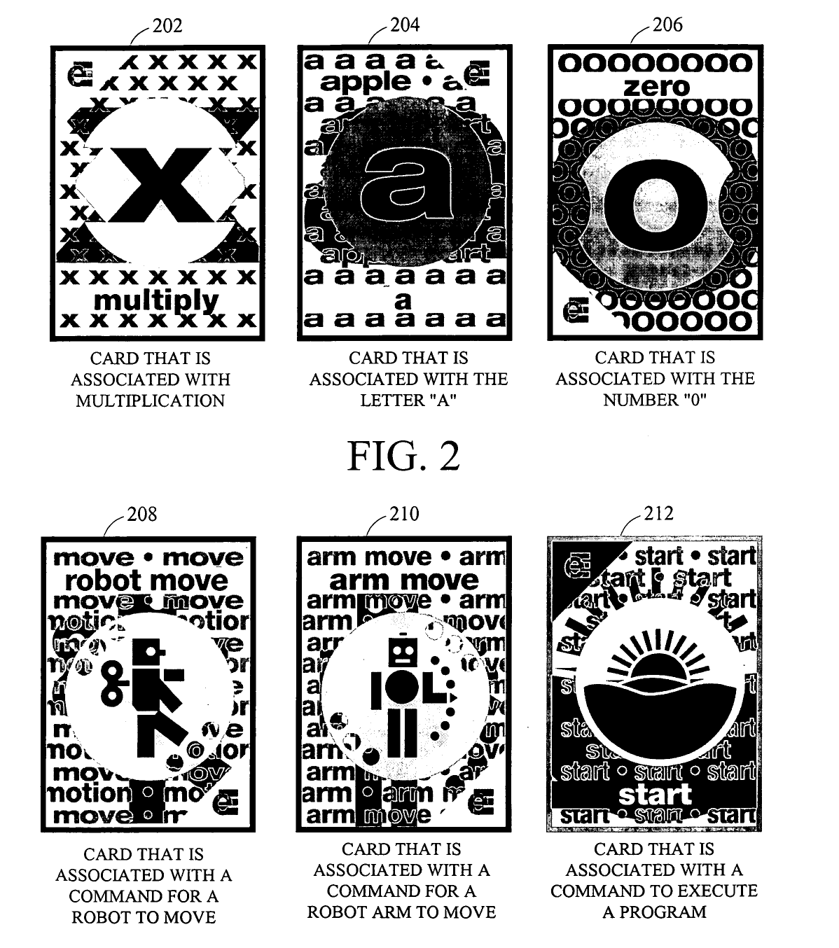

FIG. 2 illustrates examples of printed cards with visible indicia that can be identified a machine and by a human. In one embodiment, the human-readable portion of the visible indicia includes one or more words. The words advantageously permit a human to efficiently interpret the logic of a printed card. A machine-readable portion and a human-readable portion can correspond to the same parts or to different parts. In addition, the machine-readable portion and the human-readable portion can be separate, and can be on the same surface of an object or on different surfaces of an object.

A programming system can be configured to respond to a variety of types of printed cards. One implementation of the system can respond to two types of printed cards: command cards that trigger certain actions (such as stopping or listing the current program) and token cards that comprise actual program elements (tokens) of a programming language. It will be understood that in another embodiment, the system can respond to one type of card or to more than two types of cards.

A card with an “x” 202 illustrates an example of a card that can be associated with a multiplication operation. A card with an “a” 204 illustrates an example of a card that can be associated with an argument for the letter “a.” A card with a “0” 206 illustrates an example of a card that can be associated with an argument for the number zero (0). These cards can be used to form programming statements.

A card 208 illustrates an example of a card that can be associated with a command for a robot to move. The card 208 can also be associated with a macro or set of instructions that provide for the movement of a robot. A card 210 illustrates an example of a card that can be associated with a command for a robot to move a robot arm. A card 212 illustrates an example of a card that can be associated with a command to start the execution of a program. The association between a visual indicator or indicia and a corresponding instruction, macro, command, and the like, can be stored in a data store such as a database.

Process for Correcting for Imperfect Card Set Perception

Cards or objects in the environment may not be perceived with 100% accuracy, e.g., may be perceived in one cycle but not in the next (even if the object should exist in the visual field). Accordingly, it is desirable to reliably determine the actual set of cards. This is particularly desirable when the cards are associated with tokens that form a programming statement, and the parsing of that statement can fail if there are any gaps in the perceived sequence.

In a given frame or cycle, an object has a non-zero probability of not being detected, or of being mistakenly identified. The objects' physical locations in one or two dimensions can be used to help determine their relative positions. One embodiment of the system goes through a predefined set of cycles and accumulates a statistically determined probability of objects present in the sequence, along with their relative positions in the sequence. In one embodiment, only those objects with this probability above a predetermined threshold are deemed to be present in the sequence.

In one implementation, the cards recognized in a cycle are treated as a string of tokens. With a new cycle, the system accumulates a potential sequence of tokens, where some locations have multiple candidate tokens (e.g., “3” and “8”, which look similar and are relatively likely to be substituted erroneously in some cycles), and others that have only single candidate tokens. For each candidate token, the system accumulates a count, and when the preset number of cycles is completed, the system examines each supposed location in the potential sequence and determines true presence by checking for a count larger than, for example, 50% of all cycles. If the number of token changes between two cycles is relatively large, a change of card set may have occurred, and the system can start again with a new statistical measurement.

Execution Rules for Mobile Platforms

When the process is operating on a mobile platform, such as a robot, the process should properly execute program statements associated with card sequences that it encounters, but it should not repeatedly execute a same program statement corresponding to a card that merely remains in the field of view. In one implementation, the system disables the card or object scanning subsystem for a period of time after a newly found card sequence has been found and executed. This assumes that the robot may move in the given wait period and that the same card set should therefore no longer be visible. Another implementation uses the current position of the robot, provided by a method such as by odometry or by simultaneous localization and mapping (“SLAM”), and uses the orientation of the card set to mark and remember the position of the current set. The process can then wait for a period of time before executing the card set again, wait until the robot has moved away from the cards and then returned before executing the card set program again, and the like.

A Sample Application of the System

One application of the system is as a computer language and game intended to teach users about logic, programming, and robotics. In this implementation, a set of programming tasks is created (at varying levels of difficulty) and users are challenged to use the visual programming cards to program the robot to accomplish the task.

For example, users can be asked to place programming cards around a room to have the robot move from point to point on a treasure hunt. The users can be asked to help a robot successfully navigate a floor maze through the correct placement of motion-related programming cards. The users can program the robot to perform a dance timed to music.

In a single-player mode, the user can compete against time to see how quickly the user can get the robot to perform a task, or to see how few cards the user can use to accomplish the task. In a multi-player mode, users can compete with each other and even against other users who have posted their scores on an associated Web site. The other users can be located remotely and coupled to the Web site via the Internet. For example, users can create their own custom robot routines and then challenge other users to program their own robots to perform the same task. In another example, users may also play a card trading game where the cards that are exchanged correspond to programming statements and commands. In this way, a user can accumulate more capabilities for his robot.

Various embodiments of the invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A method of programming a device, the method comprising:
providing a plurality of card-like objects, where at least one surface of the card-like objects includes indicia, wherein at least a portion of the indicia is machine readable and at least a portion is human recognizable;
visually recognizing the indicia on at least some of the card-like objects using an image recognition process;
associating the recognized indicia with one or more executable program instructions; and
arranging the one or more executable program instructions to create at least a portion of a computer program.

2. The method as defined in claim 1, wherein the device that is controlled corresponds to a mobile robot.

3. The method as defined in claim 1, wherein visually recognizing further comprises using a digital camera to detect visual features of the card-like objects, where the camera views the card-like objects without touching the card-like objects.

4. The method as defined in claim 1, wherein visually recognizing further comprises using an optical scanner to recognize the one or more card-like objects, where the optical scanner recognizes the one or more card-like objects without touching the one or more card-like objects.

5. The method as defined in claim 1, wherein the indicia comprise both graphical markings and textual symbols.

6. The method as defined in claim 1, wherein the card-like objects are formed at least in part from paper, and the card-like objects are not affixed to other objects.

7. The method as defined in claim 1, wherein a card-like object corresponds to at least one of a token card and a command card.

8. The method as defined in claim 1, wherein the portion of a computer program comprises at least one of a complete program, a macro, and a sub-routine.

9. The method as defined in claim 1, further comprising:
associating the recognized indicia with one or more commands, where the commands control a programming environment and are not incorporated into an executable program; and
automatically executing the one or more associated commands to control the program.

10. The method as defined in claim 9, wherein the one or commands are selected from at least one of a save command, a program listing command, and a start program command.

11. The method as defined in claim 1, wherein visually recognizing the indicia further comprises recognizing visual features that correspond to scale-invariant features (SIFT).

12. A method of programming a device, the method comprising:
visually recognizing indicia that are visible on at least one surface of one or more planar objects, where at least one surface of the planar objects includes indicia, where at least a portion of the indicia is machine readable and at least a portion is human recognizable;
automatically associating at least some of the recognized indicia with one or more executable program instructions; and
arranging the one or more executable program instructions to create at least a portion of a computer program for the device.

13. The method as defined in claim 12, wherein the device that is programmed corresponds to a mobile robot.

14. The method as defined in claim 12, wherein visually recognizing further comprises receiving data from a digital camera to detect visual features of the planar objects, where the camera views the planar objects without contacting the planar objects.

15. The method as defined in claim 12, wherein visually recognizing further comprises receiving data from an optical scanner to recognize the one or more planar objects, where the optical scanner recognizes the one or more planar objects without contacting the one or more planar objects.

16. The method as defined in claim 12, wherein the indicia comprise both graphical markings and textual symbols.

17. The method as defined in claim 12, wherein the planar objects are formed at least in part from paper, and the planar objects are not affixed to other objects.

18. The method as defined in claim 12, wherein a planar object corresponds to at least one of a token planar object and a command planar object.

19. The method as defined in claim 12, wherein the portion of a computer program comprises at least one of a complete program, a macro, and a sub-routine.

20. The method as defined in claim 12, wherein the portion that is machine readable and the portion that is human recognizable are the same.

21. The method as defined in claim 12, further comprising associating at least some of the recognized indicia with one or more commands, where the commands are related to control of a programming environment.

22. The method as defined in claim 12, wherein visually recognizing indicia further comprises recognizing visual features that correspond to scale-invariant features (SIFT).

23. A method of controlling a machine, the method comprising:
visually observing indicia that are visible on at least a surface of an object, where the indicia are at least partially machine readable and at least partially human recognizable, where at least some of the indicia is associated with a desired behavior for the machine;
associating the recognized indicia with corresponding behavior based at least in part on data retrieved from a data store; and
controlling a behavior of the machine according to the recognized indicia.

24. The method as defined in claim 23, wherein the machine corresponds to a mobile robot.

25. The method as defined in claim 23, wherein the object is a card-like object.

26. The method as defined in claim 23, wherein at least some of the indicia are associated with command parameters and not with commands, further comprising interpreting the command parameters to at least partially control the behavior of the machine.

27. The method as defined in claim 23, wherein visually recognizing indicia further comprises:
visually observing a plurality of indicia on a plurality of objects;
associating the plurality of indicia with a plurality of desired behaviors;
arranging the plurality of desired behaviors in an order according to a visually observed arrangement of the corresponding plurality of objects; and
controlling the behavior of the machine according to the order.

28. The method as defined in claim 23, further comprising verifying that the indicia have been correctly identified by visually observing consistent data for indicia.

29. The method as defined in claim 23, wherein the recognized indicia are not associated with a product code for the corresponding object.

30. The method as defined in claim 23, wherein the recognized indicia are not associated with an identification of a content of an object.

31. The method as defined in claim 23, wherein a portion of the indicia that is machine readable and the portion of the indicia that is human recognizable are the same.

32. The method as defined in claim 23, wherein a portion of the indicia that is machine readable and a portion of the indicia that is human recognizable are on a same surface of the object.

33. The method as defined in claim 23, wherein a portion of the indicia that is machine readable and a portion of the indicia that is human recognizable are on different surfaces of the object.

34. The method as defined in claim 23, wherein a portion of the indicia that is human recognizable corresponds to one or more words written in plain text.

35. A set of computer control cards comprising:
a plurality of cards with visually-recognizable indicia, where the indicia are intended to be at least partially machine readable and are intended to be at least partially human recognizable, where the indicia are associated with at least one of computer commands and computer programming statements, where the associations between the visually-recognizable indicia and the at least one of computer commands and computer programming statements are stored in a computer data store; where the cards further comprise:
a plurality of cards with indicia associated with operators;
a plurality of cards with indicia associated with flow control;
a plurality of cards with indicia associated with actions for a computer; and
a plurality of cards with indicia associated with command parameters.

36. The set of computer control cards as defined in claim 35, wherein the computer control cards are fabricated from card stock.

37. The set of computer control cards as defined in claim 35, wherein the indicia associated with operators correspond to at least one selected from an arithmetic operator and a comparison operator.

38. The set of computer control cards as defined in claim 35, wherein the indicia associated with flow control correspond to at least one selected from a condition, a loop, and a break.

39. The set of computer control cards as defined in claim 35, wherein the indicia associated with actions correspond to actions for control of a mobile device.

40. The set of computer control cards as defined in claim 35, further comprising a computer-readable tangible medium having stored therein:
visual data corresponding to at least a machine-readable subset of the visually-observable indicia; and
associations between the visual data and at least one of computer commands and computer programming statements.

41. A computer program embodied in a tangible medium for controlling a device, the computer program comprising:
a module with instructions configured to visually recognize indicia that are visible on at least one surface of one or more planar objects, where at least one surface of the planar objects includes indicia, where at least a portion of the indicia is machine readable and at least a portion is human recognizable;
a module with instructions configured to automatically associate at least some of the recognized indicia with one or more executable program instructions; and
a module with instructions configured to arrange the one or more executable program instructions to create at least a portion of a computer program.

42. The computer program as defined in claim 41, wherein the device that is controlled corresponds to a mobile robot.

43. The computer program as defined in claim 41, wherein the module with instructions configured to visually recognize indicia further comprises instructions configured to recognize visual features that correspond to scale-invariant features (SIFT).

44. A circuit for controlling a device, the circuit comprising:
a circuit configured to visually recognize indicia that are visible on at least one surface of one or more planar objects, where at least one surface of the planar objects includes indicia, where at least a portion of the indicia is machine readable and at least a portion is human recognizable;
a circuit configured to automatically associate at least some of the recognized indicia with one or more executable program instructions; and
a circuit configured to arrange the one or more executable program instructions to create at least a portion of a computer program.

45. The circuit as defined in claim 44, wherein the device that is controlled corresponds to a mobile robot.

46. The circuit as defined in claim 44, wherein the circuit configured to visually recognize indicia is further configured to recognize visual features that correspond to scale-invariant features (SIFT).

47. A circuit for controlling a device, the circuit comprising:
means for visually recognizing indicia that are visible on at least one surface of one or more planar objects, where at least one surface of the planar objects includes indicia, where at least a portion of the indicia is machine readable and at least a portion is human recognizable;
means for automatically associating at least some of the recognized indicia with one or more executable program instructions; and
means for arranging the one or more executable program instructions to create at least a portion of a computer program.

48. The circuit as defined in claim 47, wherein the device that is controlled corresponds to a mobile robot.

49. The circuit as defined in claim 47, wherein the means for visually recognizing indicia further comprises means for recognizing visual features that correspond to scale-invariant features (SIFT).
